(19) United States
(12) Patent Application Publication
(10) Pub. No.: US 2024/0010008 A1
(43) Pub. Date: Jan. 11, 2024

(54) METHOD AND DEVICE FOR PROCESSING A WORKPIECE

(71) Applicant: HOMAG GmbH, Schopfloch (DE)

(72) Inventors: Ludwig ALBRECHT, Dornstetten-Aach (DE); Alexander KAZAKOV, Münster (DE); Felix KRESPACH, Vöhringen (DE)

(21) Appl. No.: 18/036,165

(22) PCT Filed: Nov. 8, 2021
(86) PCT No.: PCT/EP2021/080899

§ 371 Date: May 10, 2023

(30) Foreign Application Priority Data
Nov. 10, 2020 (DE) 10 2020 129 550.2

(51) Int. Cl. B41J 3/407; G06F 3/12; G06K 15/02

(52) U.S. Cl. CPC B41J 3/407; G06F 3/1288; G06F 3/1208; G06K 15/1836; G06F 3/1243

(57) ABSTRACT

Method for printing a workpiece (2) which preferably consists at least in parts of wood, wood materials, plastic or the like, comprising the steps of: preparation of printing data, on the basis of which a printing procedure is to be performed on the workpiece (2), transmitting the printing data to a printing device (10), and printing the workpiece (2) by means of the printing device (10), using the printing data, characterized in that the preparation of the printing data is carried out at least in part on a terminal server (30) which is connected to the printing device (10) via a remote data connection, preferably by accessing the Internet.

### TECHNICAL FIELD

The inventions relate to a method for processing a workpiece which preferably consists at least in parts of wood, wood materials, plastic or the like, as well as a device for performing the method. Within the scope of the inventions, processing is understood to include both shaping methods such as machining and coating procedures such as printing or 3D printing.

### PRIOR ART

In the field of furniture and components industry, workpieces usually consist of wood, wood materials, plastic or similar materials. The surfaces of the workpieces are often processed by machining and provided with different coatings and patterns.

In this regard, it is known to print in particular the narrow surfaces of workpieces with a desired pattern. For instance, EP 1 867 488 discloses a device for printing the surface of workpieces, in which e.g., an inkjet printer is used to provide the workpieces with a pattern.

Such methods and devices have proven themselves in practice. However, it has become clear that high-quality printing results can only be achieved with considerable technical and administrative effort, and that there is still room for improvement in the quality of the printing results. The same applies in particular to more complicated processing procedures, in which high-quality processing results can also only be achieved with considerable technical and administrative effort.

### DESCRIPTION OF THE INVENTIONS

It is therefore the object of the inventions to provide a method and a device of the type specified at the beginning, which enable a high quality of the processing results, in particular printing results, with reduced technical and administrative effort.

According to the inventions, this object is solved by a method according to claim 1 as well as a device according to claim 12. Particularly preferred further developments of the inventions are specified in the dependent claims.

The inventions are based on the finding that the preparation of the processing data, in particular printing data, depending on the respective requirements on the one hand constitutes a critical factor for the quality of the processing/printing results but, on the other hand, is also associated with high complexity and therefore represents one of the main reasons for the considerable technical and administrative effort. The inventions are therefore directed at relieving or supporting the local operator of a method and a device for processing, in particular printing, a workpiece in the preparation of the processing/printing data.

For this purpose, it is provided in the method according to the inventions that the preparation of the processing data, in particular printing data, is carried out at least in part on a terminal server which is connected to the processing device, in particular printing device, via a remote data connection. In this way, the complexity on the part of the local operator of a method and a device for processing, in particular printing, a workpiece can be extremely reduced since the terminal server completely or partially takes over the preparation of the processing data, in particular printing data. The operator of a method and a device for processing, in particular printing, a workpiece can thus work with considerably simpler hardware and software, and also requires less trained staff. In this regard, it is to be noted that the requirements for the preparation of the processing data, in particular printing data, are considerable when processing, in particular printing, workpieces since the limiting conditions such as in particular the properties of the workpieces are subject to greater variations.

Moreover, as the preparation of the processing data, in particular printing data, is at least in part moved to a terminal server, it becomes possible that the hardware and software capacities required for this purpose can be shared between numerous users, and therefore the effort for setting up and operating the terminal server is relatively low.

According to a further development of the inventions, it is provided that firstly a processing profile of the processing device is transmitted to the terminal server. Thus, the terminal server is enabled to precisely adjust the preparation of the processing data, in particular printing data, to the respective properties of the processing/printing device to be addressed, whereby a high quality of the processing/printing results can be achieved while the technical and administrative effort still remains low. In this regard, it is particularly preferred that a virtual processing/printing device is created in the terminal server. For example, virtual test printing or other test processing can thus be performed within the scope of preparation of the processing/printing data, whereby the processing results can already be checked in advance, before an actual, “real” processing/printing procedure is carried out. It will be obvious that significant savings, e.g., due to reduced rejects and quality improvements, can be achieved as a result.

Although the processing/printing method according to the inventions can, in principle, also be performed irrespective of the properties of the respective workpiece, it is provided according to a further development of the inventions that at least one workpiece parameter of a workpiece to be processed/printed is transmitted to the terminal server, which is preferably selected from the dimensions of a section to be processed/printed, surface properties of the section to be processed/printed and desired appearance of the section to be processed/printed, such as in particular decorative pattern, decorative color profile, degree of gloss and/or haptics. In this way, a both variable and high-quality processing/printing procedure results.

In this regard, it is particularly preferred that at least one workpiece parameter is transmitted from a machine control, which is preferably connected or integrated with the processing/printing device, to the terminal server. Thus, the processing/printing operation of the processing/printing device can be advantageously adjusted to the operation of a machine cooperating therewith—for example a conveying device—so that a rapid and low-error processing/printing procedure with high precision results.

According to a further development of the inventions, it is further provided that information and/or commands are transmitted to the terminal server by means of the client, on the basis of which the preparation of the processing/printing data is carried out. By using a client, which can be used e.g., locally in the processing/printing device, an effective and precise communication and control of the terminal server results so that the preparation of the processing/printing data can be carried out in a suitable manner. In this regard, it is particularly preferred that a preferably mobile terminal for inputting and outputting information is used as client.

According to a further development of the inventions, it is provided that the preparation of the processing/printing data is carried out on the basis of workpiece parameters, decorative data and/or the printing profile. This allows the print result to be set particularly accurately and efficiently. In this regard, it is particularly preferred that in the preparation of the printing data an allocation of decorative data to a workpiece and/or a color management is also carried out. Once again, it is shown that the method according to the inventions relieves the operator of a printing device of essential and complex procedures which are carried out in an efficient and precise manner according to the inventions, at least in part, on a terminal server. Thus, a further contribution is made to the solution of the underlying technical problem.

Although different preparation methods for the printing data are possible within the scope of the inventions, it is provided according to a further development of the inventions that the preparation of the printing data comprises rasterization and the rasterized printing data are transmitted from the terminal server to the printing device. In this way, the local operator of the printing device is supplied by the terminal server with printing data which can be printed without further, complex processing, whereby the above-stated advantages can be achieved in a particularly pronounced manner.

According to a further development of the inventions, it is further provided that the processed/printed section of the workpiece is detected by means of a detection unit, in particular a camera, and the detection result is transmitted to the terminal server. This ensures a particularly effective tracking and quality assurance of the processing/printing result, and it is enabled by the transmission of the detection result to the terminal server that measures are taken immediately, if necessary.

In this regard, it is particularly preferred that the detection result and/or a result of a simulation performed by means of the virtual processing/printing device is compared in the terminal server with a target variable, in particular the desired appearance of the processed/printed section of the workpiece and, if necessary, an optimization of the preparation of the processing/printing data, in particular the processing/printing profile, is carried out. Thus, a drastic increase in quality of the processing/printing result can be achieved, without resulting in an increased technical or administrative effort—apart from a detection device that is usually simple.

Furthermore, it is particularly preferred that the optimized processing/printing profile is transmitted from the terminal server to the processing/printing device and/or instructions are output by the terminal server to an operator for adjusting the processing/printing profile, in particular by means of the client. Thus, it is ensured that the result of the optimization is reliably included in the further processing/printing procedures and, in particular in the case of transmission of the optimized processing/printing profile to the processing/printing device, no effort is required on the part of the operator of the processing/printing device. If instructions for adjusting the processing/printing profile are output to the operator, a certain effort may result; on the other hand, the operator is enabled to include further measures for increasing the processing/printing quality by means of local limiting conditions or the own perception.

Moreover, it is provided according to a further development of the inventions that the data transmission between the terminal server and at least one (further) local unit is performed via a remote data transmission, preferably by accessing the Internet, wherein at least one local unit is selected from the client, machine control and detection unit. If required, several or even all local units can thus be connected directly or indirectly with the terminal server, resulting in an effective and rapid communication which leads to a rapid process flow and a high-quality processing/printing result.

A device for performing the method according to the inventions is the subject matter of the independent patent claim 12 and the subclaims thereof. With a simple construction and structure, these make it possible to achieve the above-stated advantages.

### BRIEF DESCRIPTION OF THE DRAWINGS

FIG. 1 schematically shows an embodiment of a device for printing a workpiece.

FIG. 2 schematically shows method steps when realizing an embodiment of the method according to the inventions.

FIG. 3 schematically shows method steps for checking the printing quality when realizing an embodiment of the method according to the inventions.

### DETAILED DESCRIPTION OF PREFERRED EMBODIMENTS

Preferred embodiments of the inventions will be described in detail below with reference to the accompanying drawings.

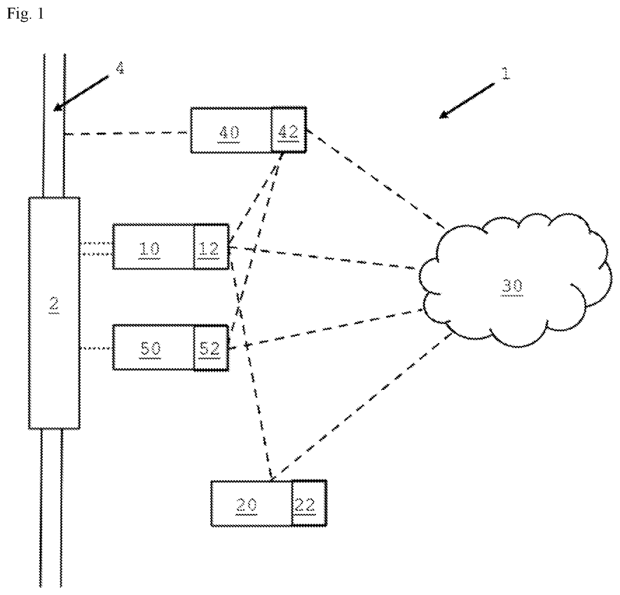

A device 1 for printing a workpiece 2 is schematically illustrated in FIG. 1 as embodiment of the present inventions. In the present embodiment, the device 1 serves for printing workpieces 2 which consist completely or partially of wood, wood materials, plastic or the like, for example, which are widely used in the furniture and components industry. In principle, every surface of the workpiece 2 can be printed; particularly often the narrow surfaces or the edges provided on the narrow surfaces are printed. However, the wide surfaces can also be provided with printing. In each case, this can also be so-called 3D printing.

Alternatively or additionally, however, the device 1 can also be configured for other types of processing a workpiece 2, such as machining or other shaping processing.

In the present embodiment, the device 1 firstly comprises a conveying device 4 by means of which the workpieces 2 are moved in relation to a printing device 10. The conveying device 4 is shown in FIG. 1, by way of example, as continuous conveying device such as a conveyor belt, transport belt or conveyor chain. However, it is to be noted that the conveying device 4 can also serve for moving the printing device 10 in relation to the workpiece 2. Hybrid forms of both concepts are also possible.

For example, the printing device 10 can be a drop-on-demand printing device, such as an inkjet printing device.

Moreover, the device 1 comprises a terminal server 30 that is arranged decentrally (“in the cloud”) in the present embodiment and is, in principle, completely free in terms of space. The terminal server serves for the preparation of printing data, as will be described in more detail below.

The terminal server 30 is connected with the printing device 10 via the Internet or another suitable remote data connection, and the printing device 10 has a remote data transfer interface 12 for this purpose.

Moreover, the device 1 in the present embodiment comprises a client 20 which serves to allow an operator to receive information, if necessary, and in turn to input information. In the present embodiment, the client is configured as mobile terminal, such as a tablet computer, and a plurality of other configurations are also possible within the scope of the inventions. The client 20 also has a remote data transfer interface 22 via which it is connected with the terminal server 30.

As apparent from FIG. 1, in the present embodiment, the device 1 further comprises a detection unit 50 which is configured as a camera, for example, and performs detection of the section of the workpiece 2 to be printed by the printing device 10. The detection unit 50 also comprises a remote data transfer interface 52 to establish a remote data connection with the terminal server 30.

Finally, the device 1 comprises a machine control 40 which is connected, in the present embodiment, with the conveying device 4 of the printing device 10 and the detection unit 50 and controls operation thereof. In order to adjust this operation also with the processes on the terminal server, the machine control 40 also has a remote data transfer interface 42 via which the machine control 40 communicates with the terminal server 30.

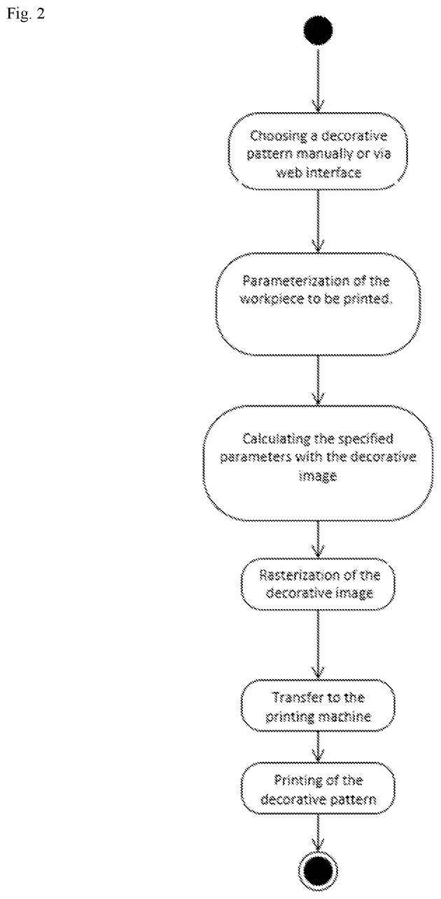

The operation of device 1 according to the inventions and the method according to the inventions are performed as follows (cf. also FIG. 2). Firstly, a printing profile of the printing device 10 is transmitted to the terminal server 30 and, if required, the terminal server 30 creates a virtual printing device in the terminal server 30 on the basis of the printing profile. Moreover, workpiece parameters of a workpiece to be printed are transmitted to the terminal server 30, for example from the machine control 40. These workpiece parameters comprise, for example, the dimensions of a section to be printed, the surface properties (color, roughness, porosity, etc.) of the section to be printed, and also the desired appearance of the section to be printed (such as in particular decorative pattern, decorative color profile, degree of gloss and/or haptics). The desired appearance can also be input or chosen by an operator, for example by using the client 20 which can store a decorative data base for this purpose or enable access to a decorative data base stored in the terminal server 30 or in another suitable place.

On the basis of at least such information, the printing data are prepared on the terminal server 30. Moreover, at this point, the decorative data—optionally chosen by the user—are also allocated to a workpiece or workpiece section and, optionally, color management also takes place. As a result of printing data preparation, rasterized printing data are available which are subsequently transmitted from the terminal server 30 to the printing device 10.

In the next step, the printing device 10 performs a printing procedure on the workpiece 2 on the basis of the rasterized printing data transmitted from the terminal server 30. Subsequently, the detection unit 50 detects the printed section of the workpiece 2 and transmits the detection result to the terminal server 30. The terminal server 30 compares the detection result with the desired appearance of the printed section of the workpiece 2 and, if necessary, performs an optimization of the printing data preparation to the effect that the actual print image is closer to the desired appearance. For this purpose, the terminal server 30 can also create an updated printing profile and transmit it to the printing device 10 so as to be stored there. Alternatively or additionally, the terminal server 30 can also output information to an operator, for example via the client 20, so that the operator can perform corresponding adjustments to the printing device 10 or at another suitable place.

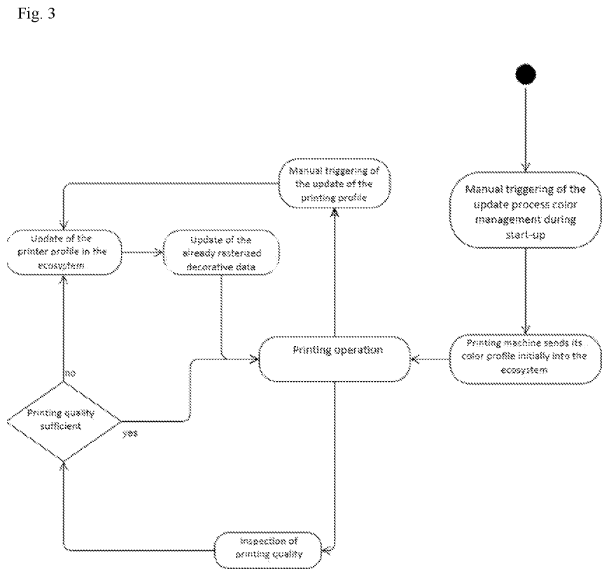

The process of checking the printing quality and, if necessary, updating the printing profile is shown schematically in FIG. 3. For example, after manual triggering of the update process “color management” during start-up, the printing device 10 initially sends its printing profile (color profile) to the terminal server 30. During the subsequent printing operation, the printing quality is inspected by means of the detection unit 50. If the printing quality is not sufficient, the terminal server 30 generates an update of the printing profile and also already rasterized decorative data and supplies these to the printing device 10, on the basis of which it performs the printing operation. As illustrated in FIG. 3, an update of the printing profile can also be triggered manually.

1. A method for processing, a workpiece, the method comprising the steps of:
preparing processing data corresponding to a desired processing procedure to be performed on the workpiece, the preparation of the processing data being carried out at least in part on a terminal server which is connected to the processing device via a remote data connection;
transmitting the processing data to a processing device; and
processing, the workpiece by means of the processing device using the processing data.

2. The method according to claim 1, wherein firstly a processing profile of the processing device is transmitted to the terminal server, and a virtual processing device is created in the terminal server.

3. The method according to claim 1, wherein at least one workpiece parameter of a workpiece to be processed is transmitted to the terminal server, the at least one workpiece parameter being selected from the dimensions of a section to be processed, surface properties of the section to be processed and desired appearance of the section to be processed, such as in particular decorative pattern, decorative color profile, degree of gloss and/or haptics.

4. The method according to claim 3, wherein the at least one workpiece parameter is transmitted from a machine control.

5. The method according to claim 1, wherein information or commands are transmitted to the terminal server by means of a client for inputting and outputting information, on the basis of which the preparation of the processing data is carried out.

6. The method according to claim 1, wherein the preparation of the processing data is carried out on the basis of workpiece parameters, decorative data, or a printing profile.

7. The method according to claim 1, wherein preparation of the processing data comprises rasterization.

8. The method according to claim 1, wherein a processed, in particular printed section of the workpiece is detected by means of a detection unit to create a detection result, the detection result being transmitted to the terminal server.

9. The method according to claim 8, wherein the detection result or a result of a simulation performed by means of a virtual processing device is compared in the terminal server with a target variable and on the basis of the comparison, the method further comprises optimizing the preparation of the processing data to create an optimized processing profile.

10. The method according to claim 9, wherein the optimized processing profile is transmitted from the terminal server to the processing device or instructions based on the optimized processing profile are output by the terminal server to an operator for adjusting the processing profile.

11. The method according to claim 1, wherein data transmission between the terminal server and at least one local unit is performed via a remote data transmission, wherein at least one local unit is selected from the client, machine control, or detection unit.

12. A device for printing on a workpiece, the device comprising:
a printing device for processing a workpiece which comprises wood, wood materials, or plastic, and
a client comprising a mobile terminal for inputting and outputting information,
wherein the processing device or the client comprises a remote data transfer interface configured to establish a remote data connection with a terminal server.

13. The device according to claim 12, further comprising a terminal server for connecting with the printing device or the client, the terminal server being configured (i) to prepare processing data on the basis of which a processing procedure is to be performed by the printing device and iii) to transmit the processing data to the printing device.

14. The device according to claim 12, further comprising a detection unit configured to detect a processed section of the workpiece and to transmit the detection result to the terminal server.

15. The method according to claim 1, wherein the processing data comprises printing data.

16. The method according to claim 1, wherein the processing device comprises a printing device.

17. The method according to claim 1, wherein the processing procedure comprises a printing procedure.
